(19) United States
(12) Patent Application Publication
(10) Pub. No.: US 2010/0313464 A1
(43) Pub. Date: Dec. 16, 2010

(54) Seat Mounted Lure Container

(76) Inventors: Lille Jeanette Bain, Camden, AR (US); Timothy Bruce Morgan, Camden, AR (US)

Correspondence Address: CORBITT LAW FIRM, PLLC, P.O. BOX 4368, LITTLE ROCK, AR, 72214, US

(21) Appl. No.: 12/814,921

(22) Filed: Jun. 14, 2010

Related U.S. Application Data
(60) Provisional application No. 61/187,536, filed on Jun. 16, 2009.

(51) Int. Cl. A01K 97/06

(52) U.S. Cl. 43/54.1

(57) ABSTRACT

A waterproof fishing lure container for storage and easy access of fishing lures and fishing gear in a mountable and detachable fashion to the boat under the fisherman's seat. The container is rectangular shaped and has a hollow shaft which closes around the fisherman's seat and is attached to the inside surface of the boat via a hinged lock-down plate for easy installation and removal. The container is mounted under the fisherman's seat on a boat for easy access to the lures while fishing.

### CROSS REFERENCE

Claiming Priority from Provisional Application 61/187,536

### FEDERALLY SPONSORED RESEARCH

None

### SEQUENCE LISTING

None

### TYPE OF APPLICATION

General Patent Application claiming priority

### ASSIGNEE

None

### BACKGROUND OF THE INVENTION

This invention relates to containers for storing fishing lures and more specifically a container that is accessible while fishing from a seated position in a boat. This container is compartmentalized and is designed to be mounted to the pedestal of a seat in a fishing boat. This container is specifically designed to be used by fisherman for quick access to their lures without having to leave their seat. The container has a plurality of rectangular sliding drawers fitted with locking devices to prevent premature opening and spilling of lures. The container is also fitted with netted and waterproof pockets on the sides for storage of wet or dry materials.

### PRIOR ART

Tackle boxes for fishing lures are well known products in the sport of fishing. The earliest fishing tackle boxes comprised a box with a hinged lid containing trays with slots to separate the different fishing lures. The inventions along with other patents in this field show the need for improvements in this area. Specifically, the needs for improvement in the area of (1) ease of access and (2) secure storage while fishing and traveling in the boat, (3) safety, and (4) time saver for the fisherman.

All the fish a fisherman catches will be in the water and while a fisherman is storing, retrieving and spending time finding the right lure, no fish will be caught. Therefore, this invention improves the fisherman's access to storage and other types of bait without having to leave the seated position. With this device the fisherman can simply remove a lure, store the lure, and retrieve a new lure without have to leave his seat or give up control of the boat. This device allows for the ease of removal and attachment facilitating the ease of transportation and removal for changing out lures. Essentially, a novice or professional fisherman would chose the tackle box needed for the lake or river that they anticipate to be fishing. The appropriate fishing box would be attached the floor of the boat via the latch shown in the drawings. Upon switching fishing lakes, ponds or rivers a different fishing box would be attached to the boat. An example of a type of seat mounted fishing tackle is illustrated in the patent to Crabtree, U.S. Pat. No. 4,999,943 and the patent to Schaefer, U.S. Pat. No. 4,745,704.These inventions are directed to seat mounted fishing tackle but fail to meet other objectives of accessibility, removability, protection from unintentional opening, and safety for the fisherman.

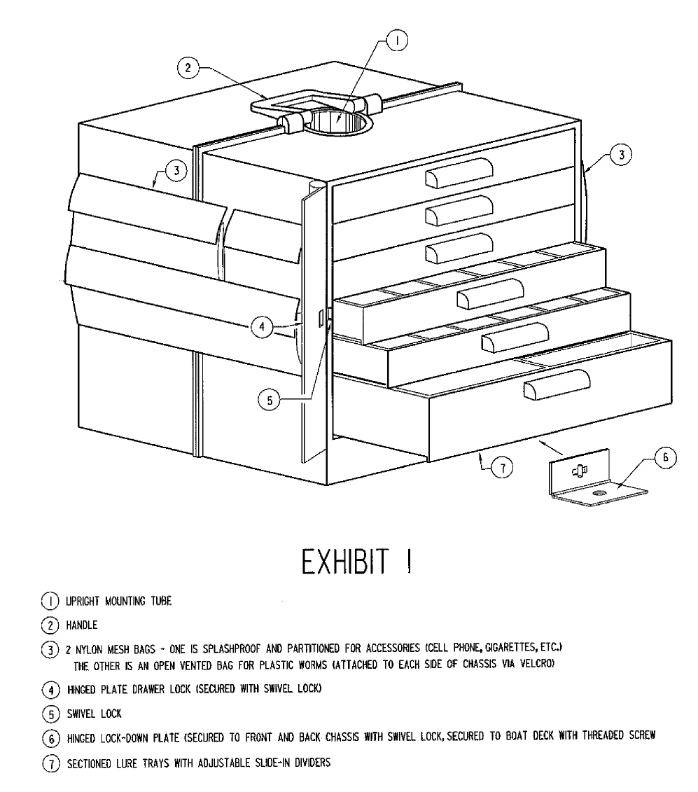

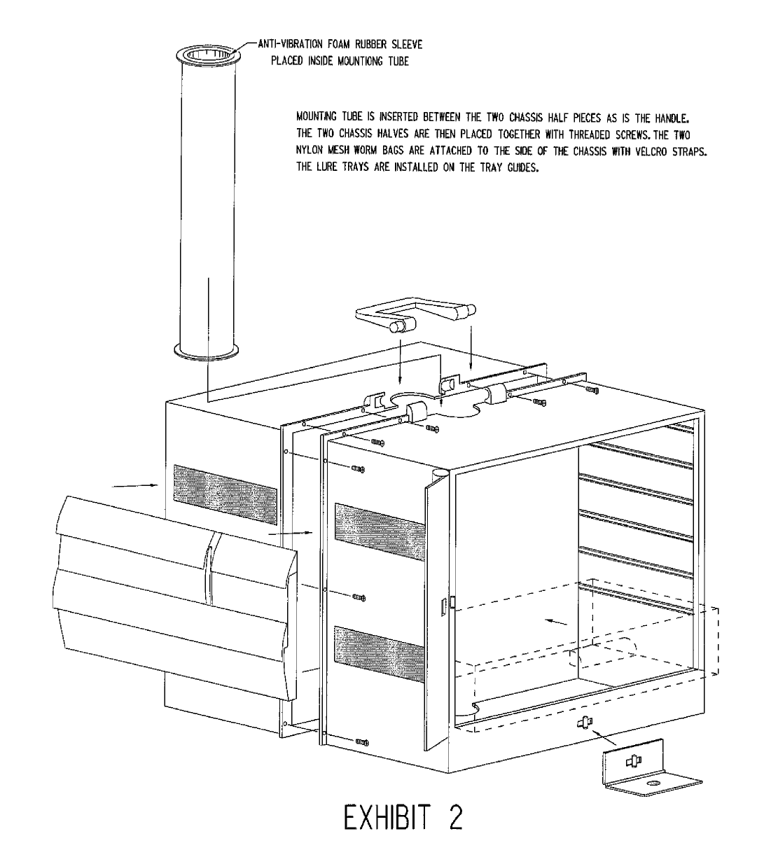

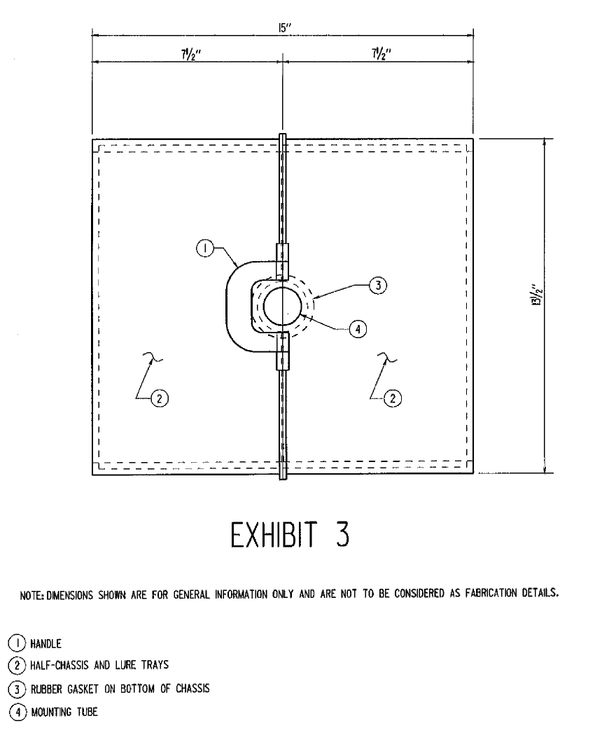

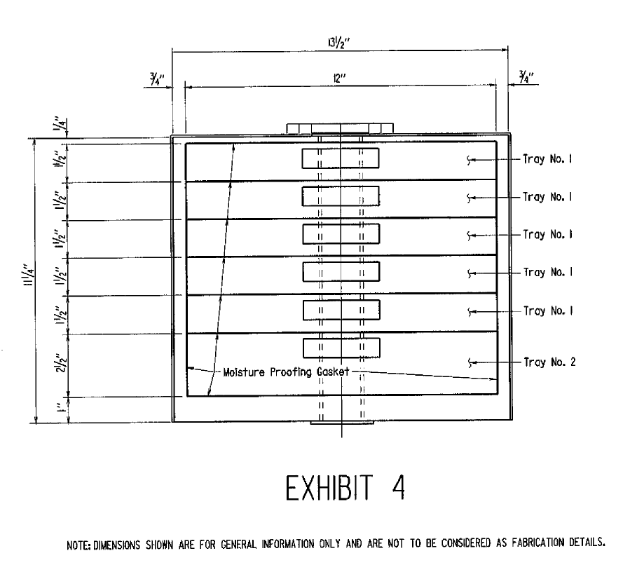

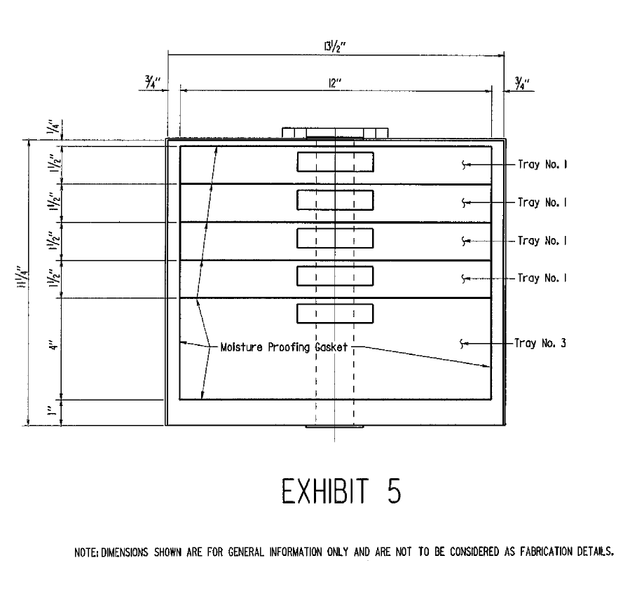

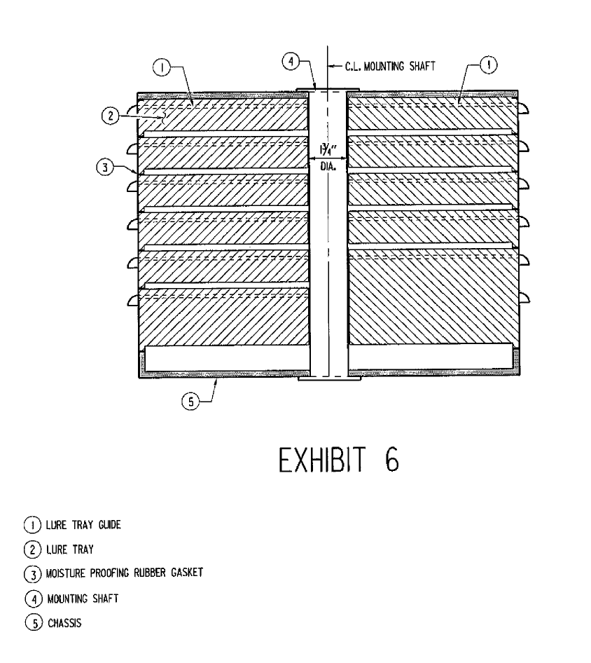

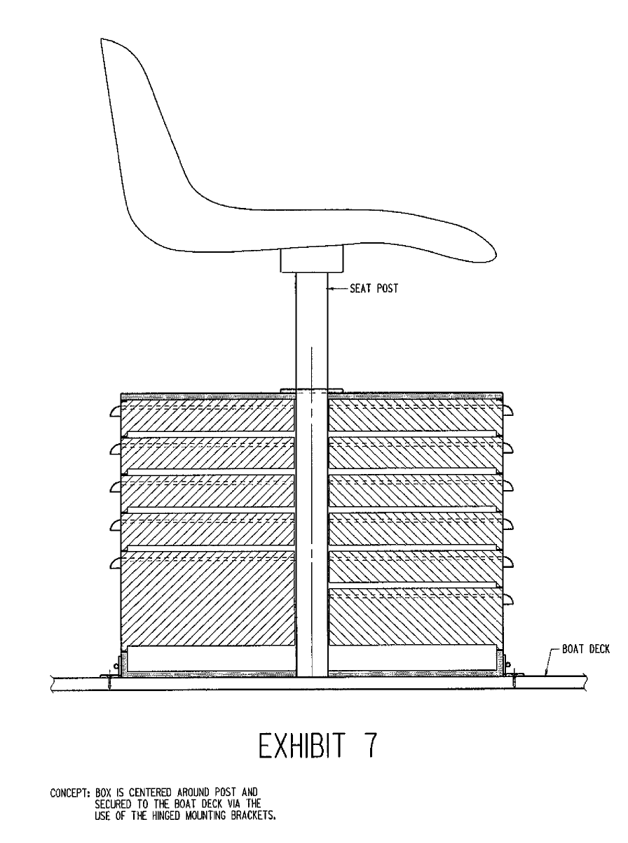

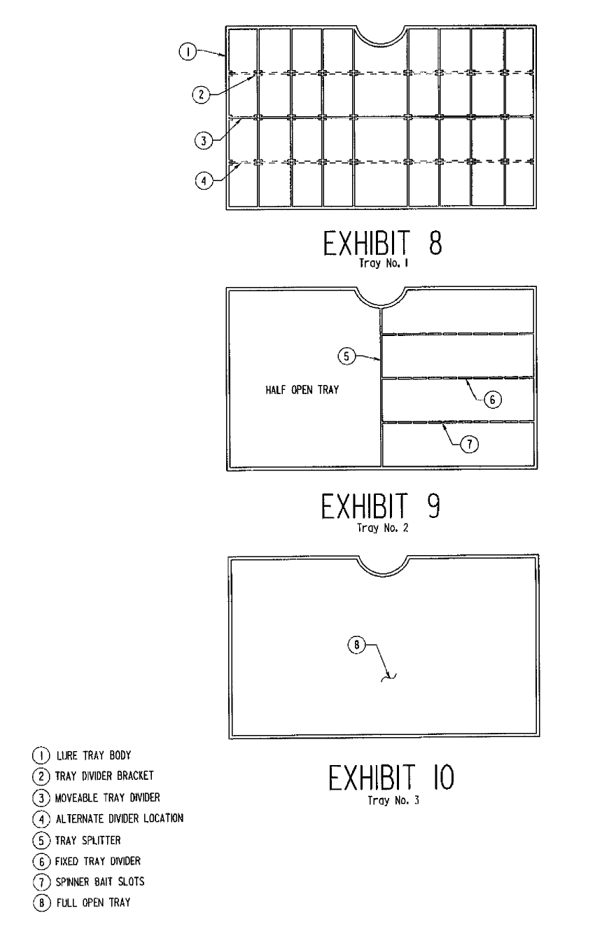

First, the present invention improves the accessibility by allowing the user to access different tackles by choosing which tackle to latch to the boat. See FIG. 2 showing the latch to the floor of the boat that allows the user to remove the entire tackle box and install a different tackle box. This is an improvement over the prior art because the other inventions in this area do not allow for ease of removing and installing a different seat mounted tackle box. The present invention has screws on the front and back side allowing the user to simply to screw one side of the tackle allowing the box to open along the center and be removed from the seat pole. The other inventions fail to show such use. The ability to be able to easily remove and attach a different tackle box is needed and this invention address that need.

Second, the present invention shown in FIG. 2 has a swivel lock that keeps the drawers from unintentionally opening preventing the loss of tackle while traveling. The need for improvement in this area is self evident because of the obvious absence of locks on the drawers in prior art.

Third, the increased need for safety of the fisherman is warranted because of the faster boats, the time limits imposed on professional fisherman in fishing tournaments, and the increased boat traffic during fishing times as more people have acquired boats for recreational purposes. The ability to choose the tackle box that is wanted before getting on the water allows the user to stay seated and access the best types of lure for the intended fishing destination.

Fourth, having access to the tackle without having to stand up and move around the boat not only limits the user to potential safety hazards of walking around on a moving boat but saves time in accessing the desired lure. This time saved can be used to keep the lure in the water and get those extras casts into the water to catch more fish.

### SUMMARY OF THE INVENTION

A compartmentalized container having a plurality of drawers is provided having a number of stacked drawers with variable slots inside the drawers. The container is rectangular shaped with a hollow shaft in the middle designed to be easily mounted and dismounted from around the pedestal of a seat mounted in a boat via a latch on one side and a hinge on the other side. The container has locking devices for the ease of mounting and dismounting the container on the floor of a boat under the seat of a fisherman. The left and right side of the container has both netted and waterproof detachable pockets. The netted pockets are designed for storage of wet lures or material and the waterproof pockets are designed for storage of items intended to be kept dry. The shaft of the seat pole is designed with a foam rubber sleeve to be mounted inside of the edges of the container allowing for a tight fit around the pole of the seat.

### DESCRIPTION OF THE DRAWINGS

Exhibit 1 shows an isometric view of the invention with drawers and a locking mechanism. Exhibit 2 shows an exploded view of the device with the detachable netted and waterproof pockets and how the device comes apart for mounting on a seat pole. Exhibit 3 shows a top of view of the device. Exhibit 4 shows a front view of the device with moisture sealing around the drawers. Exhibit 5 shows a rear view of the device. Exhibit 6 shows a center side view depicting the drawer guides and moisture proofing rubber gasket. Exhibit 7 shows a center side view with the device mounted to a boat deck and seat pole.

### DETAILED DESCRIPTION OF PREFERRED EMBODIMENT

In the drawings a rectangular tackle box designed for ease of mounting and dismounting from a seat pedestal on a fishing boat is illustrated. As shown in Exhibit 1, a tackle box is mounted to a floor via a latch 6. A handle 2 is mounted to the top of the tackle box and the tackle box is designed to be able to open and close around a seat pedestal via the mounting tube 1. On both sides of the tackle box nylon mesh netted bags 3 can be attached and detached for the storage of wet lures. As shown, in Exhibit 2, the front and back portions of the tackle box and can be assembled and disassembled from around the center seat pole. As shown in Exhibit 4 a series of vertically stacked rectangular drawers 7 can be slid open and shut for the storage of fishing lures and easily accessible while fishing in a seated position. These drawers can be locked shut via a locking hinged plate 4 shown in Exhibit 1.

What is claimed is:

1. A rectangular portable compartmentalized fishing lure receptacle having a front side and a back side, connected via screws or a hinge on the left side and a latch on the right side to connect the front side and back side allowing the receptacle to open and close around a single support member for a seat.

2. The device of claim 1 comprising:
a. a top side having a handle for raising and lowering the device, and
b. a bottom side having latches for securing the device to a floor, and
c. a plurality of sliding rectangular drawers housed in the front side and back side and stacked vertically for storage, and
d. detachable nylon mesh netted pockets along the sides of the device for storage of wet fishing lures.

3. The device of claim 1 wherein the rectangular drawers have a swivel lock to prevent unintentional opening of the drawers.
